(19) United States
(12) Patent Application Publication
(10) Pub. No.: US 2003/0190029 A1
(43) Pub. Date: Oct. 9, 2003

(54) Method and system for generating a reward from a selected telephone carrier

(75) Inventor: Kevin R. Marcus, Woodinville, WA (US)

Correspondence Address: MERCHANT & GOULD PC, P.O. BOX 2903, MINNEAPOLIS, MN, 55402-0903, US

(73) Assignee: InfoSpace, Inc.

(21) Appl. No.: 10/115,664

(22) Filed: Apr. 3, 2002

(51) Int. Cl. H04M 7/00; H04M 15/00

(52) U.S. Cl. 379/219; 379/221.01; 379/260; 379/114.1

(57) ABSTRACT

Described is a system and method that integrates a user's browsing experience with the placement of telephone calls, and to generating a revenue stream for third party service providers that direct the calls to selected telephone carriers. An autodialer runs on a computing device and routes user's calls to selected carrier's networks based on optional embodiments for carrier selection. The telephone carrier can be pre-selected by an autodialer or be user selected from an ordered list. Predetermined selections may be based on the carrier bidding the least cost, or optionally, the carrier bidding the highest reward. The rank ordering of telephone carriers can be based on a figure of merit. The telephone carriers can be rank ordered based on the carrier most often selected by the users; or optionally based on the highest reward offered to the third party service provider by the carrier.

### FIELD OF THE INVENTION

The invention relates generally to providing content over a network, and more particularly to generating a reward for a third party service provider, that directs telephone calls to a telephone carrier.

### BACKGROUND OF THE INVENTION

With the explosive growth of Web sites on the Internet, more and more useful content has become available. Although large amounts of information can be accessed over the Internet, there remain many situations where a user may still prefer to call a telephone number associated with a Web site to receive additional information. In the past, a user had to stop browsing a particular Web site with a computer and employ a telephone to complete a call to a telephone number associated with a browsed Web site. The lack of integration between Web site browsing and calling related telephone numbers has tended to reduce overall satisfaction with using the Internet.

Consider the example of a user wishing to make a dinner reservation at a restaurant associated with a Web site. Typically, the user would browse the restaurant's Web site and obtain related information such as menu, location and telephone number. Next, the user would stop browsing the restaurant's Web site and employ a telephone to complete a call to the restaurant to make a reservation. Whatever telephone carrier that happened to be associated with the telephone line employed to complete the user's call to the restaurant would charge the account associated with the telephone line for completing the call. However, the telephone carrier would not reward the third party service provider that originally provided access to the restaurant's telephone number on the Web site.

Similarly, it has been difficult to integrate the separate activities of browsing a Web site and making a telephone call when using a wireless device such as an “Internet enabled” cell phone to browse a Web site and originate a related telephone call. Typically, the functionality of an Internet enabled cell phone is limited to one task at a time, e.g., browsing a Web site or making a telephone call. In the past, the user had to change from a browsing interface an Internet enabled cell phone to another interface for completing a related telephone call. Such constraints have significantly diminished the enjoyment of the wireless browsing experience and discouraged its use with Internet enabled cell phones.

While others have tried to integrate the separate tasks of browsing a Web site and making a telephone call, these previous attempts have not provided a third party service provider that directs a user's telephone call to a selected telephone carrier with an opportunity to receive additional revenue from the selected telephone carrier.

### SUMMARY OF THE INVENTION

The invention is directed to integrating the browsing experience provided by a third party service provider with the selection of a telephone carrier to complete a call to a telephone number associated with a browsed Web site, and thereby providing an opportunity for the third party service provider to receive revenue for directing the call to the selected telephone carrier.

In one embodiment of the present invention, the third party service provider enables a telephone carrier to be a predetermined selection in exchange for providing the lowest cost to complete the telephone call for a user. The third party service provider may also enable the telephone carrier to be a predetermined or default selection in exchange for a reward paid to the third party service provider.

Yet another embodiment of the present invention provides for directing a telephone call to a telephone carrier that is selected from a ranked position in a list. The selected telephone carrier provides a reward to the third party service provider for completing the telephone call. The ranking of the position of each telephone carrier on the list can be based on the cost to complete a telephone call, frequency that each telephone carrier has been selected or the value of a reward provided to the third party service provider. In addition, the ranking of the position on the list can be based on a figure of merit such as quality of service.

Still another embodiment is directed to employing a client and a server architecture to implement the present invention. The client can enable an interface for manually entering the telephone number or selecting the telephone number in a web page.

These and various other features as well as advantages, which characterize the present invention, will be apparent from a reading of the following detailed description and a review of the associated drawings.

### BRIEF DESCRIPTION OF THE DRAWINGS

FIG. 1 illustrates a schematic block diagram showing an exemplary operating environment with a wired telephonic system;

FIG. 2 shows a schematic block diagram illustrating an exemplary operating environment with a wireless telephone system;

FIG. 3 shows a schematic block diagram illustrating yet another exemplary operating environment with a wired telephonic system that is coupled to at least one telephone carrier;

FIG. 4 illustrates a schematic block diagram showing still another exemplary operating environment with a wireless telephonic system and optional connections over a network;

FIG. 5A shows a functional block diagram illustrating a server computer;

FIG. 6 illustrates a flow diagram showing an overview for selecting a telephone carrier to complete a telephone call;

FIG. 7-A shows a flow diagram of options for selecting a telephone carrier to complete;

FIG. 7-B illustrates another flow diagram of options for selecting a telephone carrier to complete a telephone call;

FIG. 7-C shows another diagram of options for selecting a telephone carrier to complete a telephone call;

FIG. 8 illustrates a flow diagram for selecting a predetermined telephone carrier to complete a telephone call;

FIG. 9 illustrates exemplary display of a web page that includes a telephone number; and

FIG. 10 shows an exemplary user interface for selecting one of a plurality of telephone carriers to complete a call, in accordance with the invention.

### DETAILED DESCRIPTION OF THE PREFERRED EMBODIMENT

In the following detailed description of exemplary embodiments of the invention, reference is made to the accompanied drawings, which form a part hereof, and which are shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

The invention is directed at providing a method and system for integrating a user's browsing experience with the user's placement of a call to a telephone number identified during browsing, and to generating a revenue stream for a third party service provider, such as an Internet Service Provider (ISP), that directs this telephone call to a particular telephone carrier that can complete the call to the identified telephone number. The third party service provider may direct a call to a predetermined telephone carrier or enable a user to select one of several rank ordered telephone carriers.

In one embodiment, selection of a telephone carrier is predetermined by the outcome of a reverse auction, where the outcome could be the telephone carrier bidding the least cost to complete the call, or optionally, the telephone carrier bidding the highest reward to the third party service provider. In another embodiment, selection of the telephone carrier makes use of a user menu selection. The user makes selections from a rank ordering of telephone carriers displayed to the user based on a figure of merit, such as cost or quality of service; based on the carrier most often selected by the users; or optionally based on the highest reward offered to the third party service provider by the carrier. Whichever option is employed, the third party service provider is provided an opportunity to generate revenue from the selected telephone carrier for the redirection of telephone traffic.

The browsing is performed over a network that can include the “Internet.” Generally, the term Internet refers to the worldwide collection of networks and gateways that use the Transmission Control Protocol/Internet Protocol (“TCP/IP”) suite of protocols to communicate with one another. At the heart of the Internet is a backbone of high-speed data communication lines between major nodes or host computers, including thousands of commercial, government, educational, and other computer systems, that route data and messages.

The Internet has recently seen explosive growth by virtue of its ability to link computers located throughout the world. As the Internet has grown, so has the world wide web (WWW). Generally, the WWW is the total set of interlinked hypertext documents residing on HTTP servers around the world. Documents on the WWW, called pages or Web pages, are typically written in HTML (Hypertext Markup Language), XML (Extensible Markup Language) or some other markup language, identified by URLs (Uniform Resource Locators) that specify the particular machine and pathname by which a file can be accessed, and transmitted from server to end user using HTTP (Hypertext Transfer Protocol). Codes, called tags, embedded in an HTML document associate particular words and images in the document with URLs so that a user can access another file, which may literally be halfway around the world, at the press of a key or the click of a mouse. These files may contain text (in a variety of fonts and styles), graphics images, movie files, media clips, and sounds as well as Java applets, ActiveX controls, or other embedded software programs that execute when the user activates them. A user visiting a Web page also may be able to download files from an FTP site and send messages to other users via e-mail by using links on the Web page.

Typically, a WWW server is a computer connected to the Internet having facilities for storing and/or accessing content such as hypertext documents for a WWW site and running administrative software for handling requests for the stored hypertext documents. A hypertext document normally includes a number of hyperlinks, i.e., highlighted portions of text which link the document to another hypertext document possibly stored at a WWW site elsewhere on the Internet. Each hyperlink is associated with a URL that provides the location of the linked document on a server connected to the Internet and describes the document. Thus, whenever a hypertext document is retrieved from any WWW server, the document is considered retrieved from the WWW. As is known to those skilled in the art, a WWW server may also include facilities for storing and transmitting application programs, such as application programs written in the JAVA programming language from Sun Microsystems, for execution on another remotely located computer. Likewise, a WWW server may also include facilities for executing scripts and other application programs on the WWW server itself

A user may retrieve hypertext documents from the WWW via a WWW browser application program. A WWW browser, such as Netscape's NAVIGATOR® or Microsoft's INTERNET EXPLORER®, is a software application program for providing a graphical user interface to the WWW. Upon request from the user via the WWW browser, the WWW browser accesses and retrieves the desired hypertext document from the appropriate WWW server using the URL for the document and HTTP. HTTP is a higher-level protocol than TCP/IP and is designed specifically for the requirements of the WWW. HTTP is used to carry requests from a browser to a Web server and to transport pages from Web servers back to the requesting browser or client. The WWW browser may also retrieve application programs from the WWW server, such as JAVA applets, for execution on a client computer.

Electronic communication typically requires the use of a computer-readable media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media. The Internet may include networks constructed from, coupled to, or connected with any type or combination of communication media.

Computer storage media may include volatile and nonvolatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

System Operating Environment

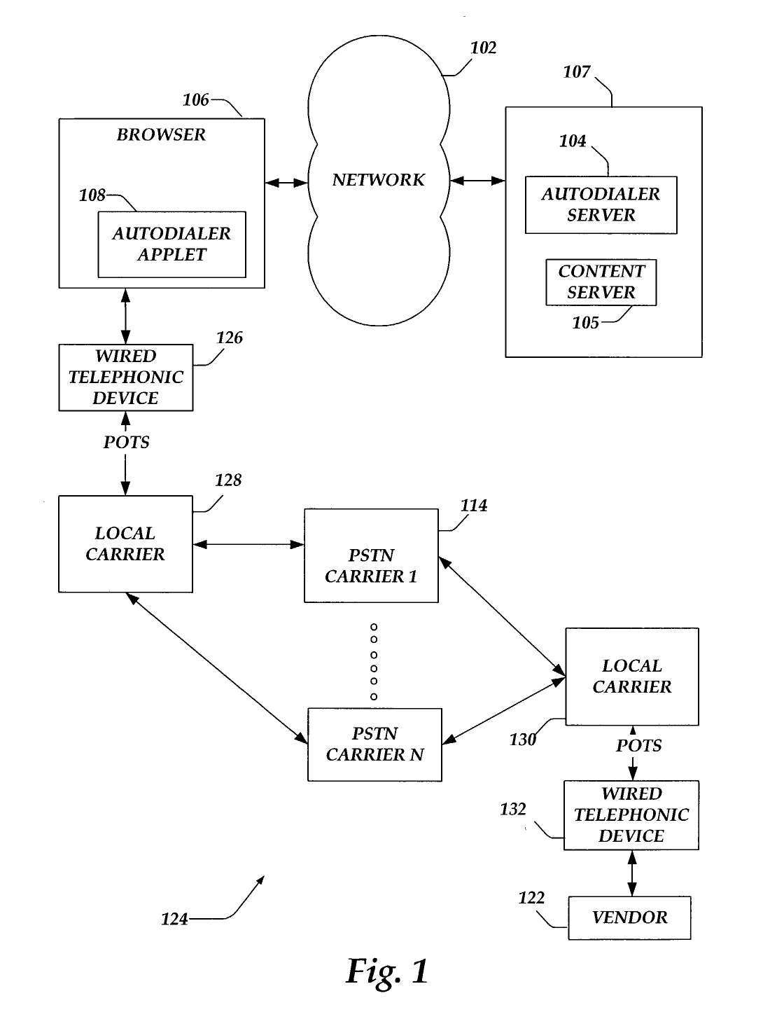

FIG. 1 shows a schematic block diagram of an exemplary system operating environment 124 that includes a wired telephonic system. The system includes network 102, autodialer server 104, browser 106, autodialer applet 108 (client-side plug-in application for the browser), wired telephonic devices 126 and 132, local carriers 128 and 130, Public Shared Telephone Network (PSTN) telephone carriers 114 (1 through N), third party service provider 107, content server 105 and vendor 122.

The network 102 can employ any form of computer readable media for communicating information from one electronic device to another. Also, network 102 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices can be remotely connected to either LANs or WANs via a modem and temporary telephone link. A remote computer may act in a number of ways, including as a WWW (content) server or a client with a browser application program.

In FIG. 1, it will be appreciated that network 102 may comprise a vast number of such interconnected networks, computers, and routers and that only a representative “cloud” is shown. As shown, third party service provider 107 and browser 106 are in communication with network 102, which provides a communication path between browser 106 and autodialer server 104. The third party service provider 107 includes content server 105, which provides requested information over network 102 for display by browser 106. Additionally, third party service provider 107 enables autodialer server 104 to be in communication with network 102.

The wired telephonic device 126 is coupled through a Plain Old Telephone Service (POTS) telephone line to local carrier 128, which in turn can be coupled to any one of the plurality of PSTN telephone carriers 114 (1 though N). The plurality of PSTN telephone carriers 114 are in communication with another local carrier 130. In addition, wired telephonic device 132 is in communication with vendor 122 and coupled by a POTS line to local carrier 130.

Autodialer applet 108 controls the operation of wired telephonic device 126, e.g., when to dial a telephone number and a particular telephone carrier's access method. An access method is any one of several means employing an access number and authorization number to place a telephone call to the provided telephone number. Also, autodialer applet 108 is capable of sending and receiving information from autodialer server 104 over network 102. Typically, autodialer applet 108 and browser 106 operate as client-side application programs that include software or instructions executing on hardware, as described, for example, in U.S. application No. 09/861446, now pending, incorporated by reference herein to the extent relevant. Such hardware can include personal computers, hand-held devices, multiprocessor systems, microprocessor-based or programmable consumer electronics, network PCs, minicomputers, mainframe computers, Internet enabled telephones (wired or wireless) and the like.

The third party service provider 107 may also enable autodialer applet 108 to access autodialer server 104 over network 102. Although not shown, the functionality of autodialer applet 108 may be implemented in a standalone application that is not integrated with a browser application.

In FIG. 1, browser 106 receives requested information from content server 105 over network 102. The requested information is displayed by browser 106. Although not shown, a telephone number associated with vendor 122 can be included in the displayed information. When a particular telephone number is selected in a displayed web page or manually entered in an interface such as a dialog box, a message that includes the selected/entered telephone number is sent to autodialer server 104 by autodialer applet 108.

Autodialer server 104 selects at least one PSTN telephone carrier to complete a call to the selected telephone number and sends the access method for each telephone carrier to autodialer applet 108, without the user's intervention and perhaps without the user's knowledge. Methods employed to select a particular PSTN telephone carrier 114 (any one of N carriers) are described in further detail elsewhere in the specification. An access method associated with a selected PSTN telephone carrier and the selected telephone number are used by autodialer applet 108 to place a call to the number.

The autodialer applet 108 provides the selected PSTN telephone carrier's access method and telephone number to wired telephonic device 126. Through local carrier 128, by way of a POTS, wired telephonic device 126 can couple to the selected PSTN telephone carrier associated with an access method. The selected PSTN telephone carrier 114 completes the call through another local carrier 130 by way of a POTS to wired telephonic device 132, which is assigned to the selected telephone number. In this exemplary embodiment, vendor 122 is associated with the selected telephone number, i.e., the intended other party in the telephone call. It is also envisioned that the locations of wired telephonic devices 126 and 132 may be so close to each other that the same local carrier may be employed by the selected PSTN telephone carrier to complete a call to the selected telephone number.

In one embodiment, the third party service provider may track the invocation of input to autodialer applet 108 (selecting a displayed or manually entered telephone number) and billing a selected PSTN telephone carrier for such invocation. In yet another embodiment, the access method of a particular PSTN telephone carrier 114 can be “hard coded” in autodialer applet 108, so that it will always be dialed in conjunction with a particular vendor's telephone number. In this case, the third party service provider would have the opportunity to charge the PSTN telephone carrier for each download of the autodialer applet.

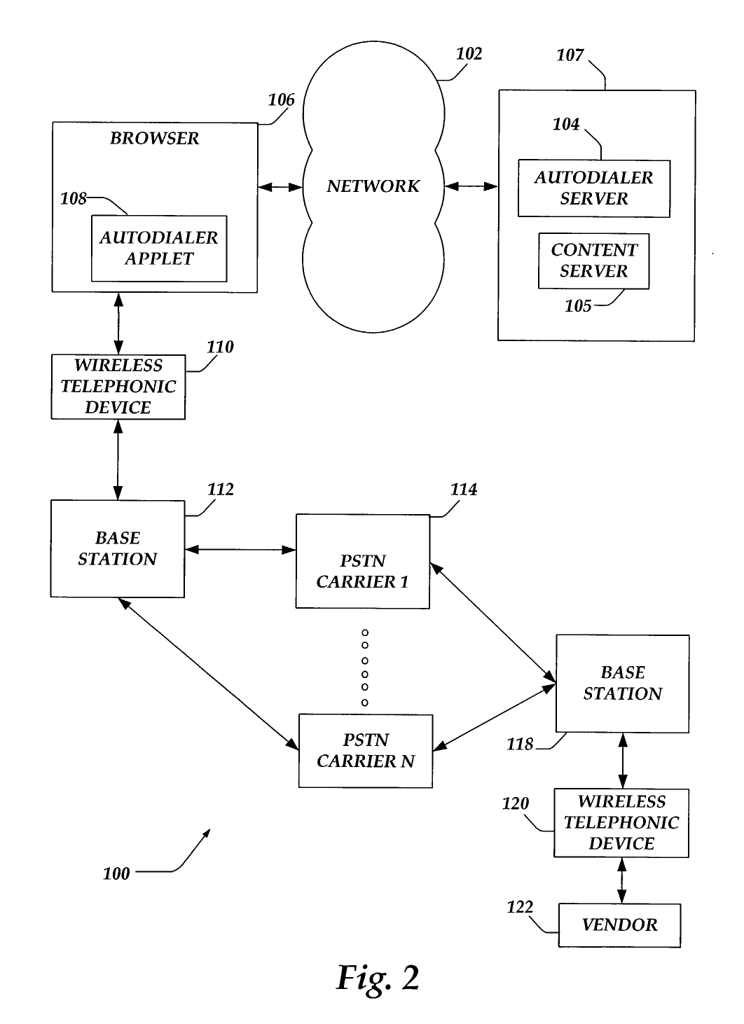

FIG. 2 shows a schematic block diagram of another exemplary system operating environment 100 that includes a wireless telephonic system. Like components in FIGS. 1 and 2 are labeled substantially the same. However, the function of wired telephonic devices 126 and 132, and local carriers 128 and 130 in FIG. 1 have been replaced by wireless telephonic devices 110 and 120, and base stations 112 and 118.

In FIG. 2, wireless telephonic device 110 is in communication with autodialer applet 108. In one embodiment, wireless telephonic device 110 is in communication with base station 112, and which in turn can be coupled to any one of the plurality of PSTN telephone carriers 114 (1 through N). The plurality of PSTN telephone carriers 114 are in communication with the other base station 118 that provides a communication path to another wireless telephonic device 120 that in turn is in communication with vendor 122.

The embodiment shown in FIG. 2 operates in substantially the same manner as the embodiment illustrated in FIG. 1. However, while FIG. 1 only shows wired telephonic devices, FIG. 2 illustrates wireless telephonic devices. Although not shown, any combination of wireless and/or wired telephonic and network interface devices can be used to facilitate communication between vendor 122, autodialer applet 108 and autodialer server 104.

In FIG. 2, autodialer applet 108 provides the access method and selected telephone number to wireless telephonic device 110. Wireless telephonic device 110 employs the access method to connect to a particular PSTN telephone carrier 114 and provides the carrier with the selected telephone number. The PSTN telephone carrier 114 completes the call to the destination, i.e., a selected telephone number that is assigned to wireless telephonic device 120 and in communication with vendor 122.

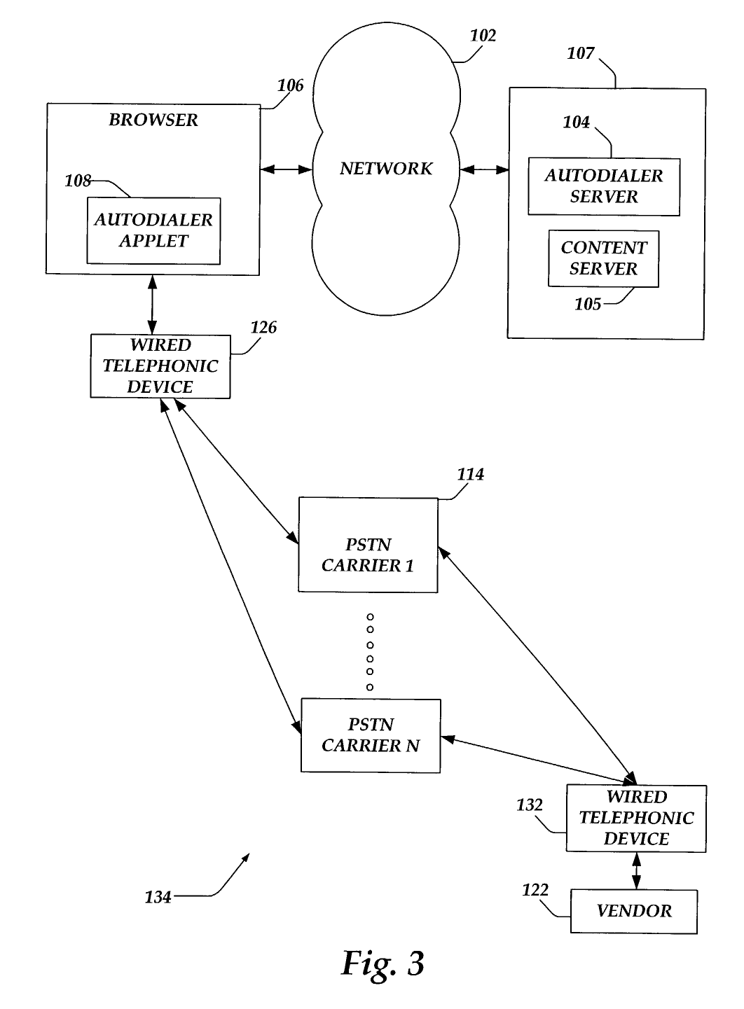

FIG. 3 shows a schematic block diagram of another exemplary system operating environment 134 that includes a wired telephonic system 134. Like components from FIGS. 1 and 3 are labeled substantially the same. However, FIG. 3 shows wired telephonic devices 126 and 132 coupled to the plurality of PSTN telephone carriers 114. Wired telephonic device 126 is in communication with autodialer applet 108 and the device can be coupled to any one of the plurality of PSTN telephone carriers 114. In addition, the other wired telephonic device 132 associated with vendor 122 can be coupled to any one of the plurality of PSTN telephone carriers 114.

Furthermore, the operating environment shown in FIG. 3 operates in substantially the same manner as FIG. 1, except that wired telephonic devices 126 and 132 are capable of communicating directly with any one of the plurality of PSTN telephone carriers 114. Although not shown in FIG. 3, wireless telephonic devices or some combination of wireless and wired telephonic devices could be employed in substantially the same manner.

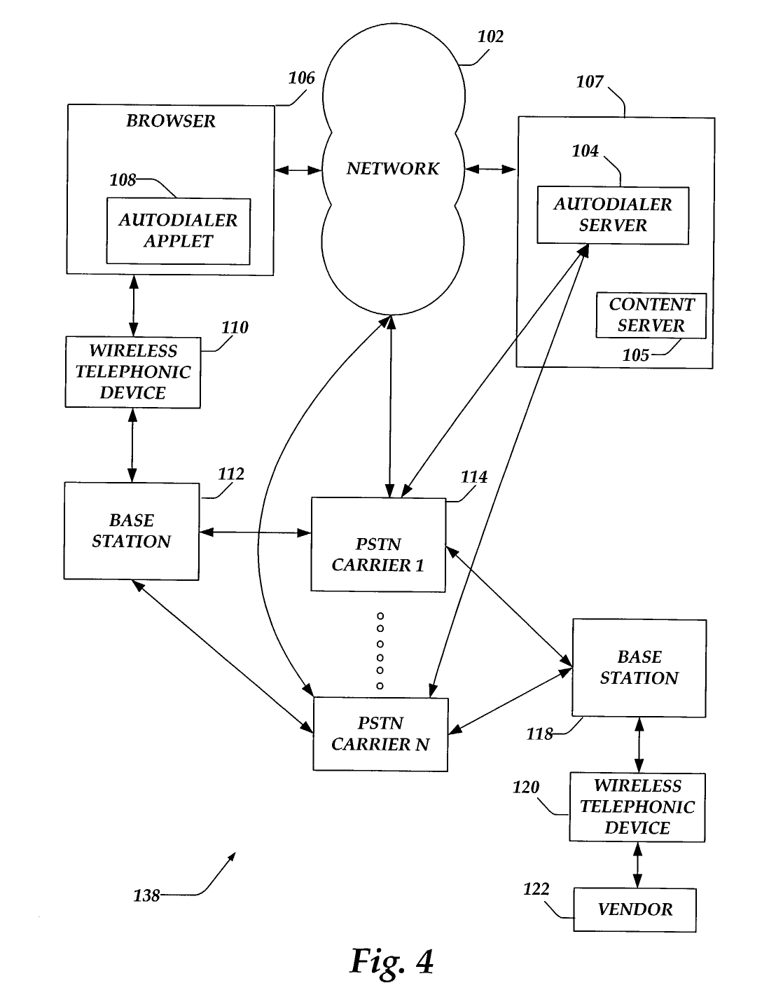

FIG. 4 shows a schematic block diagram of another exemplary system operating environment 138 that includes a wireless telephonic system. Like components from FIGS. 2 and 4 are labeled substantially the same. Optional communication paths are shown coupling network 102 to the plurality of PSTN telephone carriers 114. Also, optional communication paths are shown between autodialer server 104 and the plurality of PSTN telephone carriers 114. Moreover, the embodiment shown in FIG. 4 operates in substantially the same manner as FIG. 2, except for the plurality of PSTN carriers 114 can communicate over network 102 or directly with autodialer server 104.

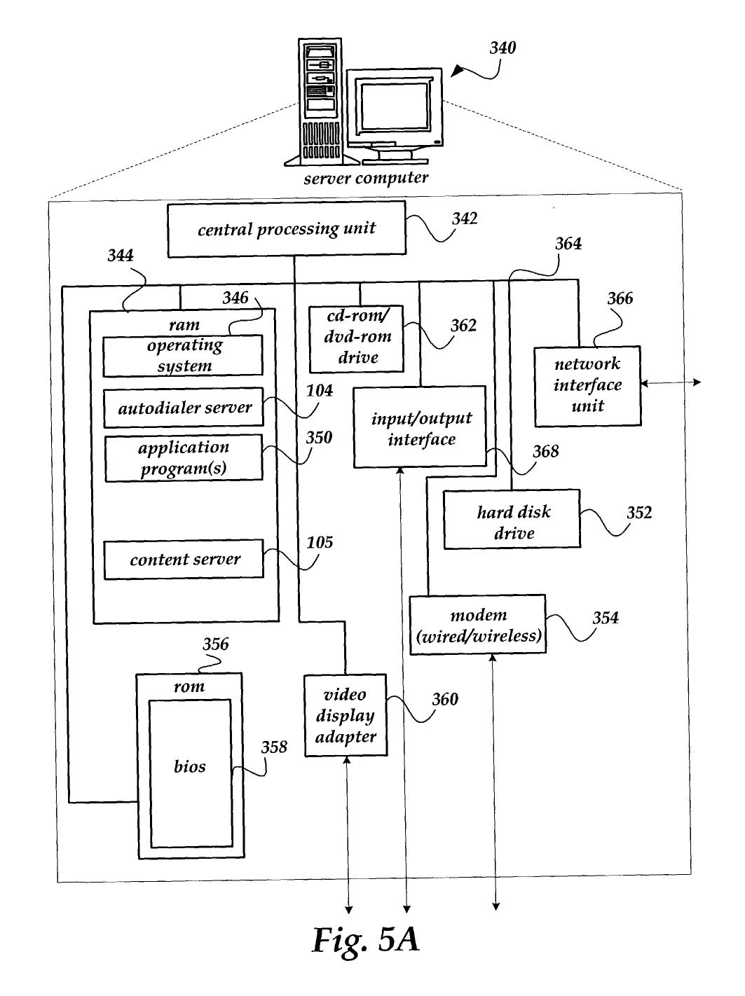

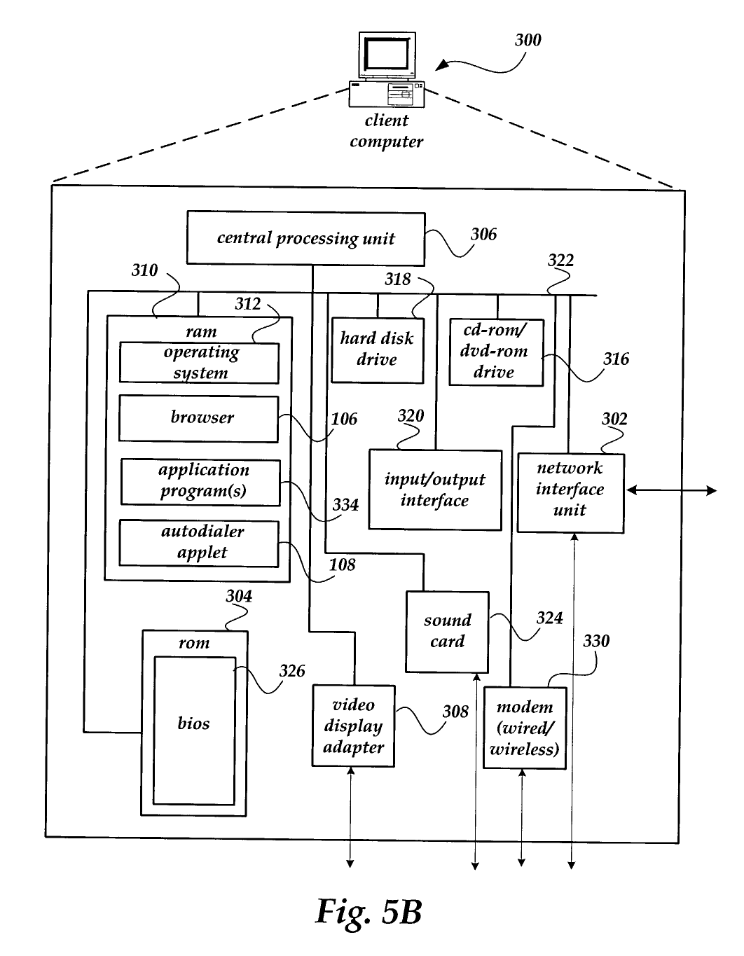

FIG. 5A shows an exemplary server computer 340 that enables the operation of autodialer server 104 and content server 105 on a network for a third party service provider. Accordingly, server computer 340 enables content server 105 to transmit information (web pages) for display by browser 106, which is executing on an exemplary client computer 300 (see FIG. 5B). For instance, server computer 340 can transmit web pages and forms for receiving information about a user, such as address, telephone number, billing information, credit card number, etc. Moreover, server computer 340 may transmit web pages to client computer 300 that allow a consumer to participate in a web site. These transactions can take place over the Internet or some other type/combination of communications networks.

The server computer 340 may include many more components than those shown. As illustrated in FIG. 5A, server computer 340 can communicate with the Internet, or some other communications network, via network interface unit 366, which is constructed for use with various communication protocols including the TCP/IP protocol.

Server computer 340 also includes processing unit 342, video display adapter 360, and a mass memory, all in communication with each other via bus 364. The mass memory generally includes RAM 344, ROM 356, and one or more permanent mass storage devices, such as hard disk drive 352, tape drive, optical drive, and/or floppy disk drive. The mass memory stores operating system 346 for controlling the operation of server computer 340. A general purpose server operating system may be employed, e.g., UNIX, LINUX™, Microsoft WINDOWS NT®, or the like. Basic input/output system (“BIOS”) 358 is also provided for controlling the low-level operation of server computer 340.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for providing a web site on a network. More specifically, the mass memory stores application programs including autodialer server 104 and content server 105. These application programs include computer executable instructions which, when executed by server computer340, generate displays and perform the logic described elsewhere in this specification. Server computer 340 also has other application programs 350 that perform logical operations. Server computer 340 may also include a JAVA virtual machine, an SMTP handler application for transmitting and receiving e-mail, an HTTP handler application for receiving and handing HTTP requests, JAVA applets for transmission to a WWW browser executing on a client computer, and an HTTPS handler application for handling secure connections. The HTTPS handler application may initiate communication with an external security application or a credit card processing application for communicating with remote financial institutions in a secure fashion.

Server computer 340 also includes input/output interface 368 for communicating with external devices, such as a mouse, keyboard, scanner, or other input devices not shown in FIG. 5A. Likewise, server computer 340 may further include additional mass storage facilities such as CD-ROM/DVD-ROM drive 362 and hard disk drive 352. Hard disk drive 352 is utilized by server computer 340 to store, among other things, application programs, databases, and program data used by content server 105 and autodialer server 104. For example, customer databases, product databases, image databases, and relational databases may be stored.

FIG. 5B depicts several components of client computer 300. Although client computer 300 may include many more components than those shown in FIG. 5A, it is not necessary that those generally conventional components be shown in order to disclose an illustrative embodiment. As shown in FIG. 5B, client computer 300 includes network interface unit 302 for connecting to a LAN or WAN, or for connecting remotely to a LAN or WAN. Network interface unit 302 includes necessary circuitry for such a connection, and is constructed for use with various communication protocols including the TCP/IP protocol, the particular network configuration of the LAN or WAN it is connecting to, and a particular type of coupling medium. Network interface unit 302 may also be capable of connecting to the Internet through a point to point protocol (“PPP”) connection or a serial line internet protocol (“SLIP”) connection as known to those skilled in the art.

Additionally, modem 354 is in communication with central processing unit 342 via bus 364 and enables server computer 340 to place a call to a telephone number. Modem 354 may be a wired and/or wireless telephonic device capable of transmitting voice and/or data.

Client computer 300 also includes BIOS 326, central processing unit 306, video display adapter 308, and memory. The memory generally includes random access memory (“RAM”) 310, read-only memory (“ROM”) 204 and a permanent mass storage device, such as a disk drive. The memory stores operating system 312, autodialer applet 108 and other application programs 334 for controlling the operation of client computer 300. The memory also includes browser 106, such as Netscape's NAVIGATOR® or Microsoft's INTERNET EXPLORER® browsers, for accessing web pages on a network such as the WWW. These application programs may be stored on a computer-readable medium and loaded into memory of client computer 300 using a drive mechanism associated with the computer-readable medium, such as a floppy drive (not shown), CD-ROM/DVD-ROM drive 316 or some other optical drive, or hard drive 318. Input/output interface 320 may also be provided for receiving input from a mouse, keyboard, or other input device. The memory, network interface unit 302, video display adapter 308, and input/output interface 320, modem 330 are all connected to central processing unit 306 via bus 322. Additionally, modem 330 may be a wired or wireless telephonic device capable of transmitting data and/or voice communications. Other peripherals may also be connected to central processing unit 306 in a similar manner.

Although not shown, it is understood that an Internet enabled wireless (cellular) telephone could perform the functionality of the client computer discussed above. The autodialer applet (client) 108 would operate in substantially the same way and communicate with the autodialer server 104 over a cellular network provided by a telephone carrier assigned to the cellular telephone. In this case, the telephone carrier selected to complete a call with the invention could be different than the telephone carrier assigned to the wireless telephone.

Selection of Telephone Carrier

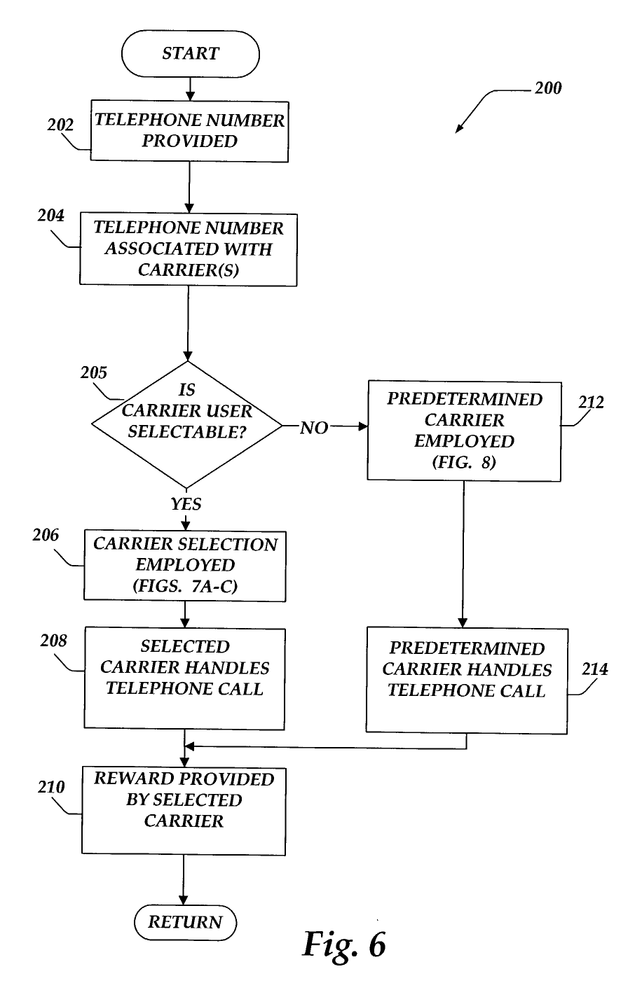

FIG. 6 shows a flow diagram illustrating a process for rewarding a third party service provider that directs telephone calls to a telephone carrier. Briefly, the telephone carrier selection process disclosed in FIG. 6 is employed to complete the user's requested telephone call and provide the third party service provider with a billing reward for directing the call to the selected telephone carrier. The telephone carrier selection and reward process 200 begins at Block 202, where a telephone number is provided. The telephone number may be manually entered in an interface displayed by a browser. Or, optionally, when a user clicks on (selects) a telephone number in a displayed Web page, the selected telephone number is automatically provided for further processing by the invention.

The process moves to Block 204 where the provided telephone number is associated with at least one telephone carrier and its access method, comprising a means of placing a call via that telephone carrier to the provided telephone number. The associated telephone carrier(s) can complete a call to the provided telephone number.

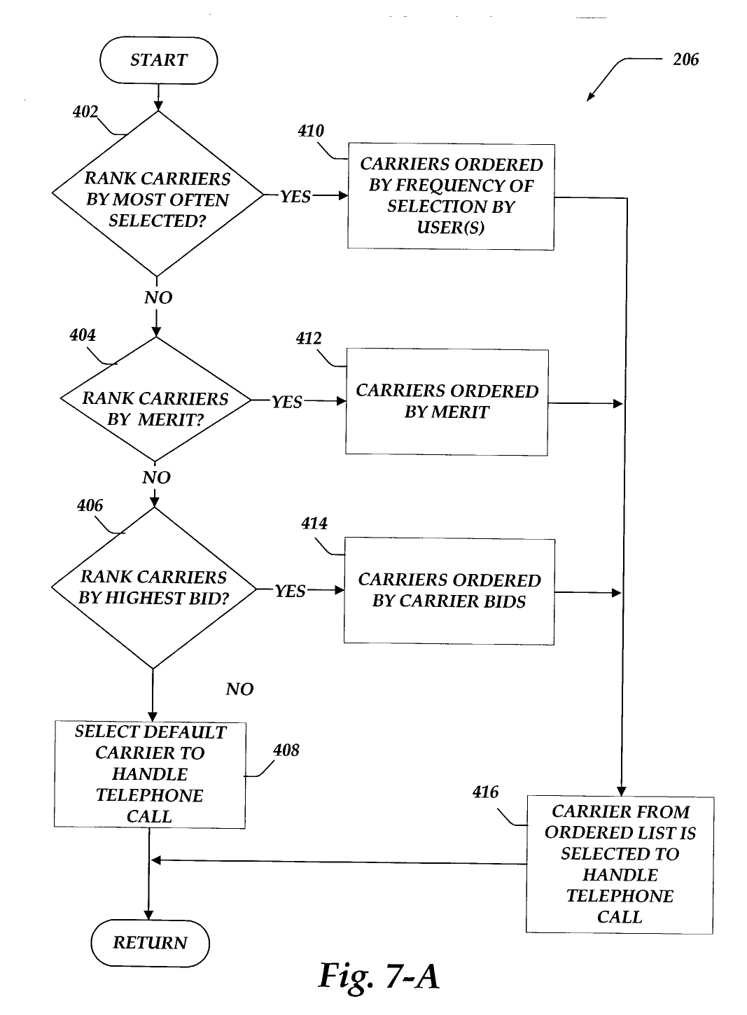

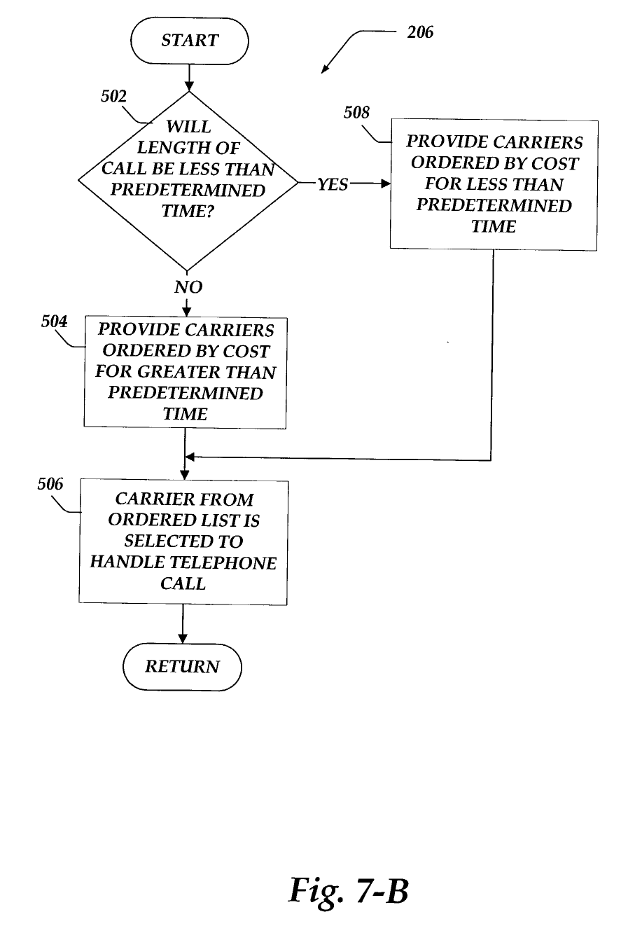

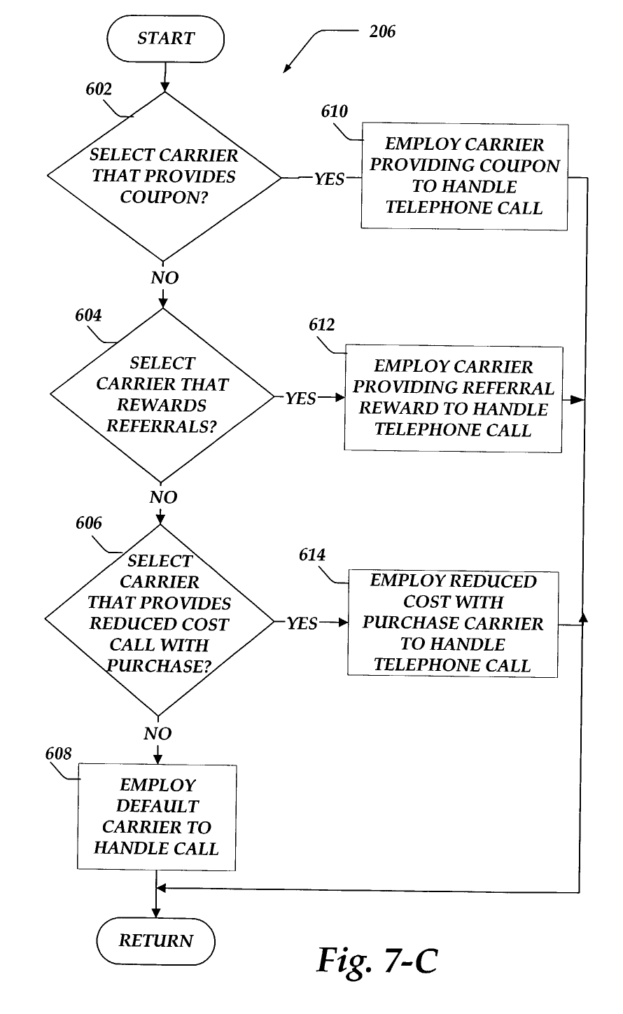

At decision Block 205, when the association of at least one telephone carrier with the provided telephone number is determined to be user selectable, the process advances to Block 206, which is discussed in further detail in FIGS. 7-A, 7-B, and 7-C. Briefly, however, various options are provided for selecting a telephone carrier to be associated with the telephone number and complete a call to that number.

At Block 208, the access method for the selected telephone carrier and the provided telephone number are employed by the carrier to complete a call to the number. The process advances to Block 210 where the third party service provider receives a financial reward from the telephone carrier for providing the opportunity to complete the call to the telephone number. Moving from Block 210, the process returns to performing other actions.

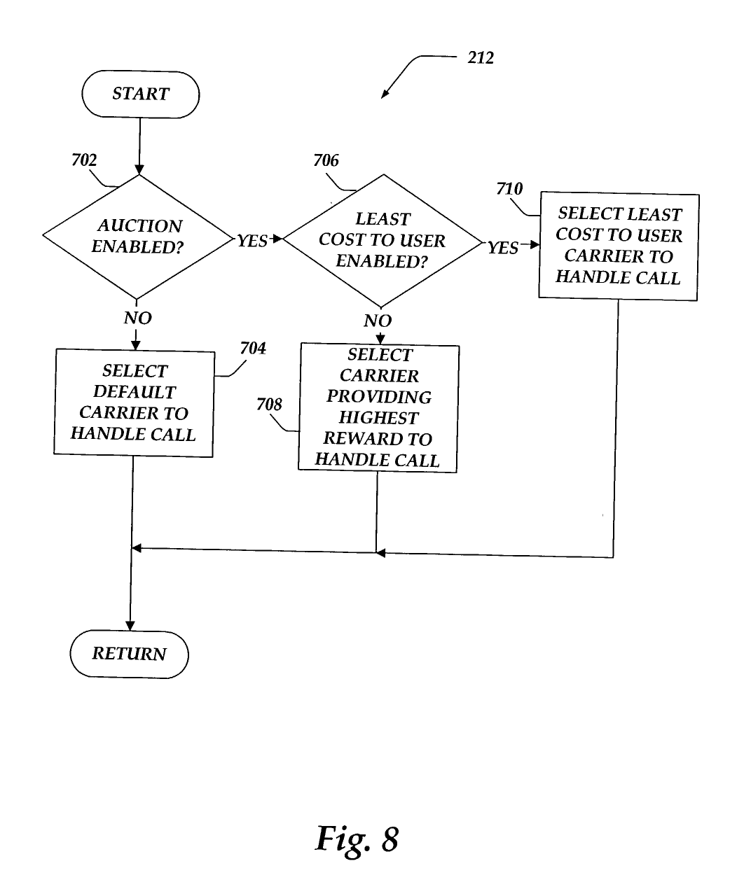

Alternatively, when it is determined at Block 205 that the telephone carrier is not selectable, the process advances to Block 212 where a predetermined telephone carrier is selected for handling the completion of a call to the provided telephone number. The selection of the predetermined telephone carrier is discussed in further detail in conjunction with FIG. 8.

The process moves to Block 214 where the predetermined telephone carrier's access method and the telephone number are employed by the predetermined telephone carrier to handle (complete) a call to the number. Next, the process advances to Block 210 where substantially the same actions discussed above are performed.

Options for Selecting Telephone Carrier

FIG. 7-A is a flow diagram further illustrating options for the selection process described above at Block 206 in FIG. 6. The process moves to Decision Block 402 where a determination is made as to whether a plurality of telephone carriers are to be rank ordered based on the frequency of their selection. It is understood that the frequency of selection may be based on the behavior of a particular user or a defined set of users. If affirmative, the process moves to Block 410 where the telephone carriers are rank ordered based on their frequency of selection and displayed in a list for selection. The process then continues to Block 416 where one of the listed telephone carriers is selected by a user. Next, the process returns to Block 208 (shown in FIG. 6) to perform other actions.

Alternatively, when the determination at decision Block 402 is negative, the process moves to decision Block 404. Another determination is made as to whether the telephone carriers are to be rank ordered based on some figure of merit. One figure of merit could be the quality of service provided by a telephone carrier.

When the determination is true at decision Block 404, the process advances to Block 412 where the telephone carriers are rank ordered based on merit and displayed in a list for selection by the user. The process continues to Block 416 where substantially the same actions discussed above are performed.

Alternatively, when the determination at decision Block 404 is false, process moves to decision Block 406. Another determination is made as to whether the telephone carriers are to be rank ordered based on bids to a third party service provider for preferred placement in a displayed list of carriers. Typically, the highest position (first position) in the displayed list would be provided to the highest bidding telephone carrier. The telephone carrier displayed at the first position in the displayed list should be the most often selected by a user. Lower positions in the displayed list of telephone carriers might entail scrolling to display these positions and as such, the telephone carriers displayed at the lower positions might be selected less often. A telephone carrier could dynamically adjust their position in the displayed list (and number of telephone calls referred to the carrier) by bidding higher when calls are needed and bidding lower when they aren't. It is understood that telephone carriers could adjust their position in the list in real time and/or at predetermined intervals.

When the determination is affirmative at decision Block 406, the process moves to Block 414 where telephone carriers are displayed in a list based on their respective bids. Proceeding to Block 416, a telephone carrier from the displayed list is selected and substantially the same actions discussed above are completed.

Alternatively, when the determination at decision Block 406 is negative, the process moves to Block 408 where a default telephone carrier is provided to complete the call. Next, the process returns to Block 208 shown in FIG. 6 and other actions are performed.

FIG. 7-B is a flow diagram further illustrating the selection process described for Block 206 in FIG. 6 based on a predicted telephone call length option. The process advances to decision Block 502 where a determination is made as to whether the predicted length of a telephone call will be less than some predetermined time, e.g., 10 minutes or less. Optionally, a plurality of choices for predetermined call lengths may be provided.

When the determination at decision Block 502 is affirmative, the process continues to Block 508 where an ordered list is displayed of telephone carriers based on their cost to complete the call for less than or equal to the predetermined time, e.g., 10 minutes or less. The process advances to Block 506 where a telephone carrier is selected to complete the call from the ordered list. Next, the process returns to Block 208 in FIG. 6 where other actions are performed.

Alternatively, when the determination at the decision Block 502 is negative (the predicted length of the telephone call is greater than the predetermined time), the process continues to Block 504 where an ordered list of telephone carriers is displayed. In this case, the ordered list of telephone carriers is based on the cost to complete a call that is predicted to be greater than the predetermined time, e.g., greater than 10 minutes. Next, the process moves to Block 506 where substantially the same actions are performed as described above.

FIG. 7-C is a flow diagram further illustrating the selection process described for Block 206 in FIG. 6 based on promotions such as those described in U.S. patent application Ser. Nos. 08/696,705 and 08/914,850, each of which is incorporated herein by reference. The promotions may include but are not limited to coupons, related purchases, referrals and characteristics of a monthly service provided by a particular telephone carrier.

Moving to decision Block 602, when it is determined that a telephone carrier that provides a coupon is selected, the process advances to Block 610. A list of with at least one telephone carrier offering a coupon may be displayed for selection by a user. At Block 610, a telephone carrier providing a coupon is selected to handle the call to the selected telephone number. Depending on the terms of the coupon, the cost to complete the call may be reduced by a specified amount. Alternatively, the coupon may be stored for later use with another call. Next, the process returns to Block 208 in FIG. 6 and continues performing other actions.

Alternatively, when the determination at decision Block 602 is negative (a carrier providing a coupon is not selected), the process moves to decision Block 604. At decision Block 604, a determination is made as to whether a telephone carrier is selected that provides a reward for a referral to another user. A list with at least one telephone carrier offering a reward for a referral may be displayed for selection by a user. When the determination at decision Block 604 is affirmative, the process advances to Block 612 where a “referral reward” telephone carrier handles the call to the selected telephone number and a reward for a referral is provided to the user. Depending on the type of reward, the cost to complete the call may be reduced or the reward may be stored for later use. Next, the process returns to Block 208 in FIG. 6 and continues performing other actions.

When the determination at decision Block 604 is negative (no telephone carrier offering a referral reward is selected), the process continues to decision Block 606 where a determination is made whether a telephone carrier is selected that provides a reduced cost to handle a call if a user makes a particular purchase. A list with at least one telephone carrier offering reduced cost to handle a call when a user makes a particular purchase is displayed. Depending upon the value to a telephone carrier of a purchase made by the user, the reduced cost for handling the telephone call can vary from a percentage discount, e.g., 10%, to a no cost (free) call. When the determination at decision Block 606 is affirmative, the process proceeds to Block 614 where the selected telephone carrier handles the call. If the user has made the particular purchase suggested by the telephone carrier, the cost to complete the call can be reduced or the value of the reduced cost may be stored by the user for later use. Next, the process returns to Block 208 in FIG. 6 and continues performing other actions.

Alternatively, when the determination at decision Block 606 is negative, the process advances to Block 608 where a default telephone carrier is employed to handle the telephone call. The process then returns to Block 208 in FIG. 6 and continues performing other actions.

Predetermined Selection of PSTN Telephone Carrier

FIG. 8 is a flow diagram further illustrating the process for selecting a predetermined carrier as discussed above for Block 212 in FIG. 6. Although an auction process is disclosed for selecting a predetermined carrier, it is understood that other embodiments may be utilized, e.g., a reverse auction, and that logical or other changes may be made without departing from the spirit or scope of the invention. The following detailed description is, therefore, not to be taken in a limiting sense.

At decision Block 702, the process determines when an auction process is enabled for selecting a telephone carrier to complete the call. When the determination at decision Block 702 is affirmative, the process proceeds to decision Block 706 where another determination is made as to whether selecting a telephone carrier on the basis of least cost to the user is enabled. When the determination at decision Block 706 is affirmative, the process proceeds to block 710 where the telephone carrier that provides the least cost to the user is selected as the predetermined carrier to handle the call. Next, the process returns to Block 214 in FIG. 6 and continues processing other actions.

Alternatively, when the determination at decision Block 706 is negative, the process moves to Block 708 where the telephone carrier that provides the highest reward is selected as the predetermined carrier. In one embodiment, the selected telephone carrier provides the highest reward to a user. In another embodiment, the selected carrier provides the highest reward to a third party service provider. The process then returns to Block 214 in FIG. 6 and continues processing other actions.

Additionally, when it is determined at decision Block 702 that an auction is not enabled, the process proceeds to Block 704 where a default telephone carrier is selected as the predetermined telephone carrier to handle the call. In one embodiment, a particular telephone carrier may provide a reward to a third party service provider so that the particular telephone carrier is always selected as the predetermined telephone carrier. Next, the process then returns to Block 214 in FIG. 6 and continues processing other actions.

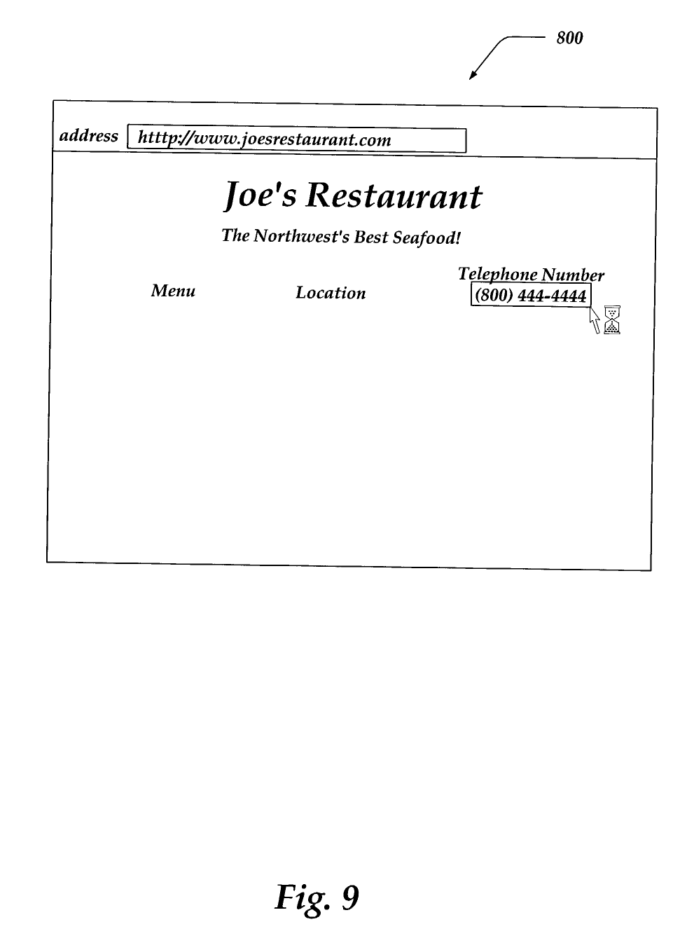

FIG. 9 illustrates an exemplary display of a web page 800 with a telephone number that can be selected by a user. In one embodiment, the selected telephone number is provided to the autodialer applet and the autodialer server to complete a call to the number.

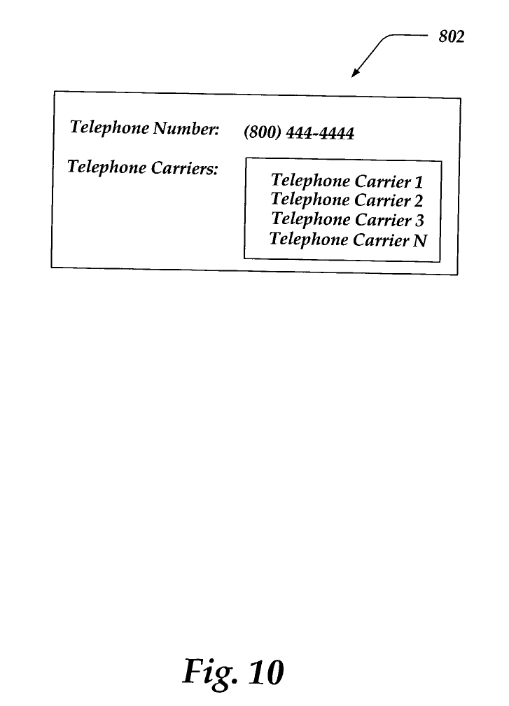

FIG. 10 shows an exemplary dialog box 802 that displays an ordered list of telephone carriers. One of the displayed telephone carriers may be selected to handle a call to the telephone number displayed in the window. In one embodiment, the selected telephone carrier is employed by the autodialer applet and the autodialer server to complete a call and enable a third party service provider to be rewarded by the selected telephone carrier.

The various embodiments of the invention may be implemented as a sequence of computer implemented steps or program modules running on a computing system and/or as interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special purpose digital logic, or any combination thereof without deviating from the spirit or scope of the present invention as recited within the claims attached hereto.

The above specification, examples and data provide a complete description of the invention. Since many embodiments of the invention can be made without departing from the spirit and scope of the invention, the invention resides in the claims hereinafter appended.

We claim:

1. A method for directing a telephone call to a telephone carrier and generating a reward therefrom, comprising:
(a) providing a telephone number to be called;
(b) selecting a telephone carrier to complete a telephone call to the provided telephone number, wherein the selection of the telephone carrier is enabled by a third party service provider; and
(c) when the telephone carrier completes the telephone call to the telephone number, enabling the third party service provider to receive a reward from the telephone carrier for providing an opportunity to complete the call to the telephone number.

2. The method of claim 1, wherein the telephone number is selected in a display provided by a browser.

3. The method of claim 1, wherein telephone number is manually provided.

4. The method of claim 1, further comprising enabling the telephone carrier to be a predetermined selection in exchange for a reward paid to the third party service provider.

5. The method of claim 1, further comprising enabling the telephone carrier to be a predetermined selection in exchange for providing the lowest cost to complete the telephone call for a user.

6. The method of claim 1, further comprising providing the telephone carrier as a default selection to complete the telephone call to the telephone number, the telephone carrier providing another reward to the third party service provider to be the default selection.

7. The method of claim 1, further comprising enabling the telephone carrier to be selected from a list, wherein each telephone carrier in the list is positioned by rank.

8. A method for directing a telephone call to a telephone carrier and generating a reward therefrom, comprising:
(a) providing a telephone number to be called;
(b) selecting a telephone carrier to complete the telephone call to the provided telephone number, wherein the telephone carrier is selected from a ranked position in a list;
(c) when the telephone carrier completes the telephone call to the telephone number, enabling the third party service provider to receive a reward from the selected telephone carrier for completing the telephone call to the telephone number.

9. The method of claim 8, further comprising ranking the position of each telephone carrier on the list based on a cost to complete the telephone call.

10. The method of claim 8, further comprising ranking the position of each telephone carrier on the list based on a frequency that each telephone carrier has been selected.

11. The method of claim 8, further comprising ranking the position of each telephone carrier on the list based on a value of the reward provided to the third party service provider.

12. The method of claim 8, further comprising ranking the position of each telephone carrier on the list based on a value of a reward provided to a user.

13. The method of claim 8, further comprising ranking the position of each telephone carrier on the list based on a figure of merit, including quality of service.

14. The method of claim 8, further comprising ranking the position of each telephone carrier on the list based on a predicted length for the call.

15. The method of claim 8, further comprising ranking the position of each telephone carrier on the list based on a promotion, the promotion including one of coupon, referral reward and reduced cost with purchase.

16. The method of claim 15, wherein the promotion is storable for later use.

17. A system for completing a telephone call with a telephone carrier and generating a reward therefrom, comprising:
(a) a client that enables a telephone number to be provided and the telephone carrier to be selected for completing the telephone call to the provided telephone number; and
(b) a server that enables a third party service provider to receive a reward from the selected telephone carrier for completing the call to the telephone number.

18. The system of claim 17, wherein the telephone carrier carries the telephone call on a public shared telephone network (PSTN).

19. The system of claim 17, further comprising employing a wireless telephonic device to complete the telephone call to the telephone number.

20. The system of claim 17, further comprising employing a wired telephonic device to complete the telephone call to the telephone number.

21. The system of claim 17, wherein the client enables an interface for providing the telephone number in a web page that is provided over a network, including manually entering the telephone number and selecting the telephone number in the web page.

22. The system of claim 17, wherein the telephone carrier provides a reward to the third party service provider for each client distributed to a user.

23. A system for directing a telephone call to a telephone carrier and generating a reward therefrom, including a server that performs actions, comprising:
(a) determining when a telephone number is provided in an interface;
(b) enabling the selection of the telephone carrier to complete a call to the telephone number; and
(c) when the telephone carrier completes the call to the telephone number, enabling the third party service provider to receive a reward from the selected telephone carrier that completes the call to the telephone number.

24. A system for directing a telephone call to a telephone carrier and generating a reward therefrom, including a client that performs actions, comprising:
(a) determining when a telephone number is provided in an interface;
(b) enabling the telephone carrier to be selected to complete a call to the telephone number, wherein the telephone carrier is selected in the interface; and
(c) enabling the third party service provider to receive a reward from the selected telephone carrier that completes the call to the telephone number.

25. A method for directing a telephone call to a telephone carrier and generating a reward therefrom, comprising:
(a) means for determining when a telephone number is provided;
(b) means for selecting a telephone carrier to complete a call to the provided telephone number, wherein the selection of the telephone carrier is enabled by the third party service provider; and
(c) means for enabling the third party service provider to receive a reward from the telephone carrier for providing an opportunity to complete the call to the telephone number.

26. A method for electronically generating a reward from a telephone carrier that completes a telephone call, comprising:
(a) enabling a third party service provider to determine when a telephone number is provided;
(b) selecting a telephone carrier to complete a call to the provided telephone number; and
(c) enabling the third party service provider to receive a reward from the selected telephone carrier that completes the call to the telephone number.
